(19) United States
(12) Patent Application Publication
(10) Pub. No.: US 2012/0072891 A1
(43) Pub. Date: Mar. 22, 2012

(54) Computer Language Syntax for Automatic Callback Function Generation

(76) Inventor: Joseph Raymond Hewitt, Palo Alto, CA (US)

(21) Appl. No.: 12/884,539

(22) Filed: Sep. 17, 2010

(51) Int. Cl. G06F 9/45

(52) U.S. Cl. 717/143

(57) ABSTRACT

In one embodiment, a compiler parses a function call that invokes a function and a first symbol associated with the function call; and in response to the first symbol, generates a first set of code that, when executed, determines whether the function is associated with an activity; and if the function is associated with an activity, then: creates a first callback function for the activity; and associates the first callback function with the activity so that the first callback function is automatically invoked when the activity is completed.

### TECHNICAL FIELD

The present disclosure generally relates to a computer programming language and its associated compiler and more specifically relates to a syntax of a computer programming language that causes a compiler for the computer programming language to automatically generate code that supports asynchronous programming features.

### BACKGROUND

In the context of computer programming, asynchronous events are those events, actions, or activities occurring independently of the main program flow. Typically, asynchronous activities are executed in a non-blocking scheme, thus allowing the main program flow to continue processing without having to wait for the asynchronous activities to complete. Asynchronous operations are typically used to perform tasks that may take a relatively long time to complete, such as opening large files, connecting to remote computers, or querying a database. When an application calls a function or method to perform an operation asynchronously, the application can continue executing while the asynchronous function performs its task.

The complexity of computer software programs continues to grow. For example, in a network or a client-server environment, software programs executing on different devices often need to coordinate with each other in order to support activities that involve multiple devices (e.g., uploading or downloading data between a server and a client). Such activities are often treated as asynchronous activities so that they do not block the main program flows while the activities are being performed. As another example, many software programs enable their users to interact with the programs (e.g., providing user input to the programs while the programs execute) via some form of user interface. Such user-interactive programs typically employ asynchronous programming to handle the user-input events. In these cases, asynchronous programming has performance benefits over synchronous programming. On the other hand, asynchronous programming is more complex than synchronous programming and requires special code to support and correctly handle the asynchronous activities. Consequently, programming in asynchronous mode requires software programmers to write additional and often complex code.

### SUMMARY

The present disclosure generally relates to a computer programming language and its associated compiler.

In particular embodiments, the present invention is directed to a syntax of a computer programming language that causes a compiler for the computer programming language to automatically generate code that supports asynchronous programming features.

In particular embodiments, a compiler parses a function call that invokes a function and a first symbol associated with the function call; and in response to the first symbol, generates a first set of code that, when executed, determines whether the function is associated with an activity; and if the function is associated with an activity, then: creates a first callback function for the activity; and associates the first callback function with the activity so that the first callback function is automatically invoked when the activity is completed.

These and other features, aspects, and advantages of the disclosure are described in more detail below in the detailed description and in conjunction with the following figures.

### BRIEF DESCRIPTION OF THE DRAWINGS

FIG. 1 illustrates an example method for automatically constructing a callback function for an asynchronous activity.

FIG. 2 illustrates an example method for automatically constructing a callback function for updating a variable.

FIG. 3 illustrates an example method for a callback function to be associated with an object.

FIG. 4 illustrates an example computer system.

### DESCRIPTION OF EXAMPLE EMBODIMENTS

The present disclosure is now described in detail with reference to a few embodiments thereof as illustrated in the accompanying drawings. In the following description, numerous specific details are set forth in order to provide a thorough understanding of the present disclosure. However, the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Asynchronous programming is applicable in various situations. For example, a software program may need the result of an event, an action, or an activity. The activity may take some time to complete. In this case, the activity may be treated as an asynchronous activity so that while it is being performed, the main program flow may continue (i.e., performing the activity does not block the main program flow) and other code may be executed. To do so, typically, an asynchronous callback function, also referred to as an event handler, may be created for and associated with the activity. In computer programming, a callback is a reference to a piece of executable code that is passed as an argument to other code, which allows a lower-level software layer to call a function, a subroutine, or a method defined in a higher-level layer. The callback function may include code that handles the result of the activity. When the activity is completed, the callback function is invoked and executed automatically with the result of the activity (e.g., the result of the activity is passed to the callback function as an argument).

Programming in asynchronous mode is usually very complex and time consuming because every asynchronous event, action, or activity requires its own callback function. In practice, a software program may involve many asynchronous activities (e.g., hundreds, even thousands), and consequently, many callback functions need to be written. In addition, each callback function may require specific code to handle the result of a particular activity.

To help simplify asynchronous programming, particular embodiments may define syntax for a programming language and implement a compiler for the programming language. In particular embodiments, the programming language is called the “HI programming language”, and the compiler for the HI programming language is called the “HI compiler”. In particular embodiments, the syntax of the HI programming language includes a number of predefined symbols and coding formats, which may be used in the source code written in the HI programming language. In particular embodiments, a predefined symbol may be a combination of alphabets (e.g., letters “a” to “z” and “A” to “Z”), numbers (e.g., digits 0 to 9), or signs (e.g., “!”, “.”, “;”, “#”, “̂”, “&”, “*”, “-”, “_”, etc.) Each predefined symbol may cause the HI compiler to perform a specific task when the source code is complied. In particular embodiments, at least some of the predefined symbols of the HI programming language help simplify asynchronous programming and thus making it convenient for programmers to write code in the HI programming language that supports asynchronous activities.

In particular embodiments, the HI compiler may translate source code written in the HI programming language into corresponding source code written in another suitable programming language (e.g., the C or C++ programming language). The HI compiler may automatically generate additional source code in the other programming language in response to specific predefined symbols and coding formats included in the source code written in the HI programming language. The source code generated by the HI compiler based on the original source code written in the HI programming language may then be compiled into object code (i.e., a collection separate, named sequence of machine code), which may then be directly executed on computing devices (e.g., computers, mobile devices, etc.). In this case, the HI programming language may be considered a compiled language.

Alternatively, in particular embodiments, the HI programming language may be an interpreted language, where source code written in the HI programming language is indirectly executed (i.e., interpreted) on computing devices by an interpreter program, called the “HI interpreter”. The HI interpreter may provide a runtime environment for the source code written in the HI programming language. The HI compiler may function in connection with the HI interpreter and dynamically (e.g., at runtime) generate additional source code in response to specific predefined symbols and coding formats included in the source code written in the HI programming language. In particular embodiments, the additional source code dynamically generated by the HI compiler may also be written in the HI programming language or another suitable interpreted language. In particular embodiments, the HI compiler and the HI interpreter may be combined into a single software suite. In particular embodiments, the HI interpreter may reside on the same computing device where software programs written in the HI programming language are executed. Alternatively, the HI interpreter may reside on a computing device different from the computing devices software programs written in the HI programming language are executed (e.g., in a client-server architecture).

In particular embodiments, source code written in the HI programming language may be stored in a file (e.g., an ASCII file) with a “.hi” extension. The HI compiler and the HI interpreter may be designed to treat any file with the “.hi” extension as containing source code written in the HI programming language. In particular embodiments, the HI compiler and the HI interpreter themselves are computer software written in any suitable language (e.g., the C, C++, or Java programming language).

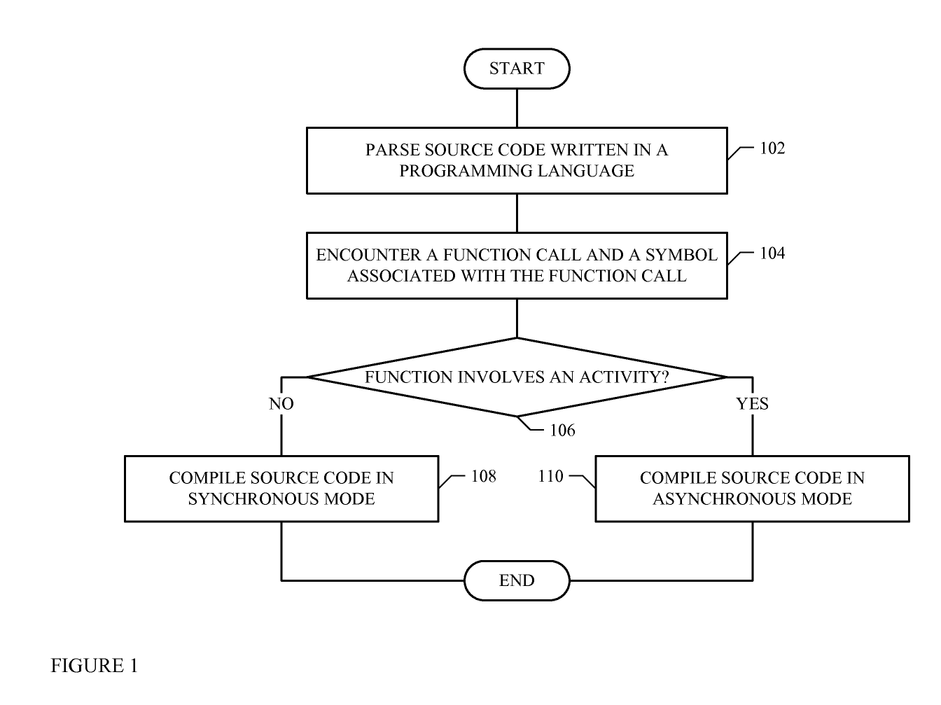

FIG. 1 illustrates an example method for automatically constructing a callback function for an asynchronous activity. In particular embodiments, there may be a block of source code written in the HI programming language. The block of source code may be compiled by the HI compiler. In particular embodiments, the HI compiler may parse the block of source code written in the HI programming language, as illustrated in step 102.

Suppose the block of source code includes a function call and a predefined symbol of the HI programming language that may be associated with any function call. In the context of computer programming, a function (also called procedure, method, subroutine, routine) is a portion of code written within a larger program that usually performs a specific task and is relatively independent of the remaining code. A call to a function invokes that function. In particular embodiments, the predefined symbol is a unique symbol known to the HI complier, which signals to the HI compiler that the associated function may involve an asynchronous activity. This symbol may be associated with any function call in the source code written in the HI programming language, whether or not the function being called actually involves an activity. Of course, it is not necessary for all function calls to be associated with the predefined symbol. For example, consider the following line of source code written in the HI programming language:

| | |
|---|---|
| 1 | user = userwithId(‘john-smith’)... |

### Code Sample 1

### A Function Call Followed by a Symbol in the HI Programming Language

In the above CODE SAMPLE 1, “userwithId (‘john-smith’)” is a call to a function named “userwithId ( )”, which may retrieve some information concerning a user whose identifier (ID) is “john-smith”. Here, “john-smith” is an argument passed to the function “userwithId ( )” when the function is invoked. The result returned by the function is assigned to a variable “user”. Following the function call is a predefined symbol “ . . . ”. In particular embodiments, this symbol may be associated with any function call (e.g., placed immediately after the function call) in the source code written in the HI programming language to notify the HI compiler that the function associated with the symbol may involve an asynchronous activity. As one skilled in the art will recognize, other symbols can be used to signal the compiler of asynchronous activity.

As the HI compiler parses the block of source code, the HI compiler may encounter the function call (e.g., “userwithId (‘john-smith’)”) and the predefined symbol (e.g., “ . . . ”) associated with the function call, as illustrated in step 104. In particular embodiments, upon encountering and in response to this predefined symbol, “ . . . ”, the HI compiler may automatically generate code that, when executed, analyzes the function call (e.g., “userwithId (‘john-smith’)”) associated with the predefined symbol (e.g., “ . . . ”) to determine whether the function being invoked (i.e., called) is associated with an activity, as illustrated in step 106. In particular embodiments, a function is associated with an activity if the function requires the result of that activity.

In particular embodiments, if the function does not involve any activity (step 106, “NO”), then the HI compiler generates source code, for example, in the C programming language, that corresponds to the original function call in the HI programming language in synchronous mode, as illustrated in step 108. In particular embodiments, the HI compiler may translate the function call in the HI programming language to a corresponding function call in the C programming language.

On the other hand, if the function involves an activity (step 106, “YES”), then the HI compiler generates source code in the C programming language that corresponds to the function call in the HI programming language in asynchronous mode, as illustrated in step 110. In this case, since the function requires the result of the activity, and the activity may take some time to complete for its result to become available, it is more desirable to handle the activity in an asynchronous scheme so that the function call does not block the main program flow while waiting for the activity to complete. In particular embodiments, the HI compiler may automatically generate source code that, when executed, creates an asynchronous callback function for the activity associated with the original function being called, and associates the callback function with the activity so that the asynchronous callback function is automatically invoked when the activity is completed. In particular embodiments, the HI compiler may generate source code that registers the callback function as an observer for the activity. When the activity is completed, the callback function is automatically invoked and the result of the activity may be passed to the callback function upon its invocation as an argument. The callback function may include code that appropriately handles the result of the activity. The following is an example of the code generated by the HI compiler for the line of code written in the HI programming language illustrated in CODE SAMPLE 1.

| | |
|---|---|
| 1 | scope = HiScopeCreate(self, outerScope); |
| 2 | e0[0].value = str_9; |
| 3 | // Gets “userWithId” function |
| 4 | e1 = HiScopeGet(scope, _userWithId); |
| 5 | // Calls userWithId and stores return value in e2 |
| 6 | e2 = HiCall(e1, e0); |
| 7 | // Checks if return of userWithId is an activity |
| 8 | if (HiIsActivity(e2)) { |

| | |
|---|---|
| 9 | e5 = e5 ? HiActivityRecreate((HiActivity*)e5, 1) |

: HiActivityCreate(1);

| | |
|---|---|
| 10 | HiActivitySetActiveObject((HiActivity*)e5, |

HiActivityGetActiveObject((HiActivity*)e2));

| | |
|---|---|
| 11 | e3[0] = e5; |
| 12 | // Creates the callback function |
| 13 | e4 = HiFunctionCreateExtras (Function_fb_1_0, |

scope, e3, 1, xclosure, 3, NULL);

| | |
|---|---|
| 14 | // Registers the callback as an observer of the |

activity

| | |
|---|---|
| 15 | HiAddObserver(e2, e4); |
| 16 | // Remembers the pair of objects being observed |

so it can be unobserved later

| | |
|---|---|
| 17 | HiActivitySetPair((HiActivity*)e5, 0, e2, e4); |
| 18 | HiPropertySetValue(prop, e5); |
| 19 | return e5; |

| | |
|---|---|
| 20 | } |

### Code Sample 2

### Code Generated by the HI Compiler in the C Programming Language

In the above CODE SAMPLE 2, at line 6 is the corresponding function call written in the C programming language, which achieves the same result as the function call “userwithId (‘john-smith’)” written in the HI programming language. At line 8, the code generated by the HI compiler determines whether the function ““userwithId ( )” involves an activity. At line 13, a callback function is generated if the function involves an activity. At line 15, the callback function is registered as an observer of the activity so that the callback function may be automatically involved when the activity is completed. Note that the code between lines 8 and 20 is executed only if the function involves an activity (i.e., the if statement evaluates to TRUE). Therefore, the callback function is generated only if the original function being called (i.e., the function call written in the HI programming language) involves an activity, in which case the code generated by the HI compiler proceeds in asynchronous mode. If the original function being called does not involve an activity, no callback function is generated, in which case the code generated by the HI compiler proceeds in synchronous mode. At line 6, the function itself is invoked regardless of whether the function involves an activity.

In particular embodiments, upon encountering a function call that is associated with a predefined symbol “ . . . ” (e.g., the predefined symbol “ . . . ” immediately follows the function call) in source code written in the HI programming language, the HI compiler automatically generates source code in the C programming language or another suitable programming language. The generated C source code, when executed, may invoke the original function in the HI source code with a corresponding function call, determine whether the function involves an activity, and if the function involves an activity, generate a callback function for the activity that may be automatically invoked when the activity is completed. In particular embodiments, the generated C source code may then be complied into object code using a suitable C compiler for execution on computing devices. The predefined symbol “ . . . ” causes the HI compiler to automatically support an activity associated with a function in asynchronous mode (e.g., generating C source code that, when executed, creates a callback function for and associates the callback function with the activity). Consequently, programmers do not need to manually write code for a separate callback function for each asynchronous activity involved in their programs, thus significantly simplifying asynchronous programming.

Sometimes, as an activity is being performed, a progress indicator may be display to show the current status of the activity (e.g., how much work has been completed). One type of activity that may require some time to complete is loading a file, such as loading an image file for display in a user interface. Sometimes, a progress indicator (e.g., a progress bar or a timer) may be displayed while an image is loaded to illustrate how much data have been loaded already at a given time. In particular embodiments, there is a predefined symbol “ImageActivity” that may be associated with an activity (e.g., loading a file). This predefined symbol causes the HI compiler to automatically generate code that displays a progress bar that shows the current status of the activity (e.g., the loading of an image). The following source code written in the HI programming language illustrates an example of using the predefined symbol “ImageActivity”.

| | |
|---|---|
| 1 | location = − |
| 2 | image = imageLoader.load(#activity)... ImageActivity |

### Code Sample 3

### Usage of “Imageactivity” Symbol in the HI Programming Language

In the above CODE SAMPLE 3, the symbol “ImageActivity” is placed after a function call that causes an image to be loaded. Upon encountering this symbol, the HI compiler may automatically generate code that displays a progress indicator (e.g., a progress bar or a timer) and a callback function associated with the progress indicator. The callback function may be automatically invoked when the amount of image data being loaded changes so that the progress indicator may be updated accordingly.

In particular embodiments, the code generated by the HI compiler in response to the “ImageActivity” symbol illustrated in CODE SAMPLE 3 may correspond to the function call “HiActivitySetActiveObject” at line 10 in CODE SAMPLE 2. This code causes the image activity to be stored as an active object, thus allowing it to be used subsequently to show the progress of the activity (e.g., the loading of an image).

Sometimes, the value of a variable of a software program may need to be updated from time to time resulting from changes occurred while the program is being executed. For example, suppose a software program provides a user interface that enables a user of the program to manage his user account. The user may select a name and an icon for his account, which may be displayed in the user interface of the program. The user has the option to change the name or the icon associated with his account whenever he desires. If the user chooses to do so (e.g., selecting a new image as the icon associated with his account), the updated name or icon is displayed in the user interface.

Typically, in such cases, a callback function is created for and associated with each variable whose value may be updated from time to time. If the value of a variable changes due to any reason, its corresponding callback function is automatically invoked. The new value of the variable may be passed to the variable's callback function as an argument. The callback function may include code that handles the value update for the variable appropriately.

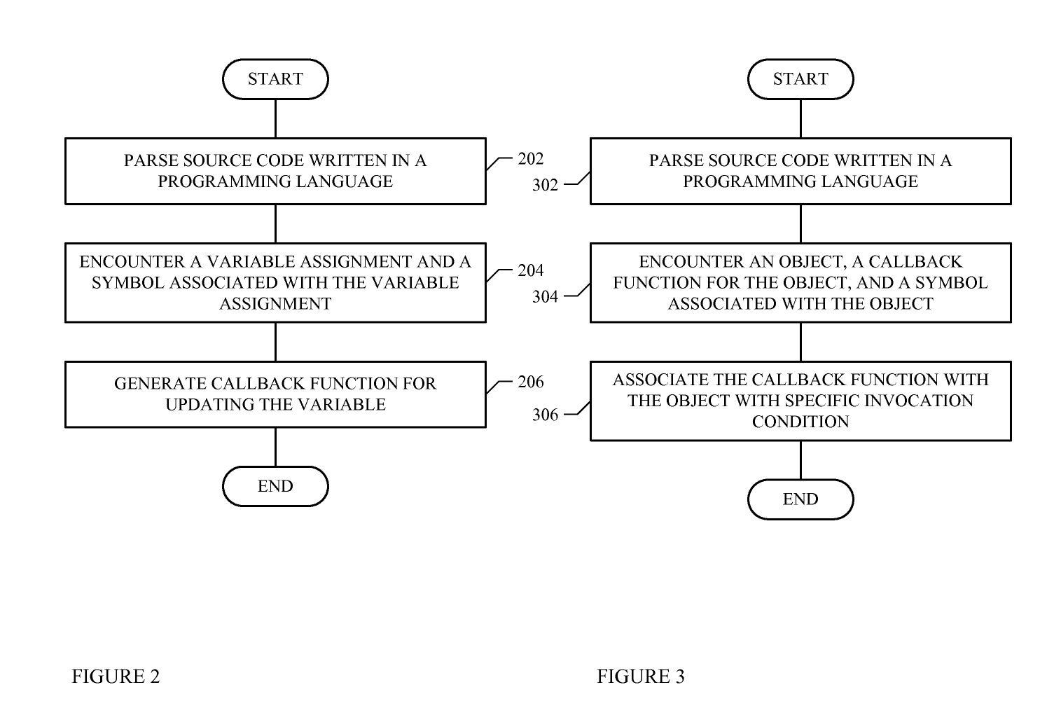

FIG. 2 illustrates an example method for automatically constructing a callback function for updating a variable. In particular embodiments, there may be a block of source code written in the HI programming language. The block of source code may be compiled by the HI compiler. In particular embodiments, the HI compiler may parse the block of source code written in the HI programming language, as illustrated in step 202.

Suppose the block of source code includes a variable assignment and a predefined symbol of the HI programming language that may be associated with any variable assignment. In particular embodiments, the predefined symbol is a unique symbol known to the HI complier, which signals to the HI compiler that the value of the associated variable may be updated from time to time. This predefined symbol may be associated with any variable assignment in the source code written in the HI programming language. Of course, it is not necessary for all variable assignments to be associated with the predefined symbol. For example, consider the following source code written in the HI programming language:

| | |
|---|---|
| 1 | title = #app.user.name |
| 2 | icon = #app.user.pictureSquare |

### Code Sample 4

### Variable Assignments Associated with a Symbol in the HI Programming Language

In the above CODE SAMPLE 4, there are two variable assignments. At line 1, variable “title” is assigned the value “app.user.name”. At line 2, variable “icon” is assigned the value “app.user.pictureSquare”. There is a predefined symbol, “#”, associated with each variable assignment. In particular embodiments, this symbol may be associated with any variable assignment (e.g., placed immediately before the value assigned to the variable) in the source code written in the HI programming language to notify the HI compiler that the value of the variable associated with the symbol may be updated from time to time.

As the HI compiler parses the block of source code, the HI compiler may encounter the variable assignment (e.g., “title=#app.user.name”) and the predefined symbol (e.g., “#”) associated with the variable assignment, as illustrated in step 204. In particular embodiments, upon encountering and in response to this predefined symbol, “#”, the HI compiler may automatically generate code that, when executed, creates an asynchronous callback function for the variable, and associates the callback function with the variable so that the asynchronous callback function is automatically invoked when the value of the variable is changed, as illustrated in step 206. In particular embodiments, the HI compiler may generate source code that registers the callback function as an observer for the variable. The callback function may subscribe to changes to the value of the variable. For example, the callback function may be registered as an event handler for the variable. Whenever the value of the variable is changed, the callback function is automatically invoked and the new value of the variable may be passed to the callback function upon its invocation as an argument. The callback function may include code that appropriately handles the new value of the variable (e.g., assigning the new value to the variable). The following is an example of the code generated by the HI compiler for the code written in the HI programming language illustrated in CODE SAMPLE 5.

| | |
|---|---|
| 1 | e5 = HiGetWithProperty(e3, HI_pictureSquare, &e4); |
| 2 | if (e4) |

| | |
|---|---|
| 3 | HiBindingBind( |

(HiBinding*)HiPropertyGetChangeBinding(prop, self),
HiPropertyGetBindingObservable(e4));

### Code Sample 5

### Code Generated by the HI Compiler in the C Programming Language

In the example illustrated in CODE SAMPLE 5, the code causes the value of “pictureSquare” to be retrieved from “e3”, which represents the value of “app.user”. The “property” object representing where “pictureSquare” is stored is also retrieved. Then the code causes a bind to the pictureSquare property so that, subsequently, whenever its value changes, a notification is received.

Asynchronous programming is often applied to operations in connection with components included in a user interface of a software program. Examples of user-interface components may include menu bar, pull-down menu, menu item, button, check box, text filed, etc. Each user-interface component enables a user of the program to interact with the program by, for example, providing input to the program through the user-interface component (e.g., selecting a menu item, clicking a button, or entering text in a text field). In some cases, a group of user-interface components may be arranged and presented in a hierarchy. For example, a menu bar may include any number of pull-down menus, and each pull-down menu may further include any number of sub-menus or menu items.

In particular embodiments, a predefined symbol may be established for each type of user-interface component, and a predefined coding format may be used to define the hierarchy of a group of user-interface components. These predefined symbols and coding format may be used in source code written in the HI programming language. When the source code is compiled by the HI compiler, each symbol or coding format may cause the HI compiler to generate appropriate code in support of the symbol or coding format. The following is an example block of source code written in the HI programming language that, when executed, displays a menu bar in a user interface.

| | |
|---|---|
| 1 | * MenuBar |

| | |
|---|---|
| 2 | * Menu |

| | |
|---|---|
| 3 | title = ‘Facebook’ |
| 4 | * MenuItem |

| | |
|---|---|
| 5 | title = ‘About Facebook...’ |

| | |
|---|---|
| 6 | * Menu |

| | |
|---|---|
| 7 | title = ‘File’ |
| 8 | * MenuItem |

| | |
|---|---|
| 9 | title = ‘Reload’ |
| 10 | key = ‘CMD+R’ |
| 11 | on command: |

| | |
|---|---|
| 12 | feedList.reload( ) |

| | |
|---|---|
| 13 | * MenuItem |

| | |
|---|---|
| 14 | title = ‘Quit’ |
| 15 | key = ‘CMD+Q’ |
| 16 | on command: |

| | |
|---|---|
| 17 | exit( ) |

### Code Sample 6

### Code for a Menu Bar in the C Programming Language

In the above CODE SAMPLE 6, at line 1 a menu bar is defined. This particular menu bar includes two menus (e.g., pull-down menus), defined at lines 2 and 6 respectively. The title of the first menu is “Facebook”, which is defined at line 3. There is one menu item included in the first menu, defined at line 4, whose title is “About Facebook . . . ” defined at line 5. The title of the second menu is “File”, which is defined at line 7. There are two menu items included in the second menu, defined at lines 8 and 13 respectively. The titles of the two menu items are “Reload” and “Quit” defined at lines 9 and 14 respectively.

In particular embodiments, there is a predefined symbol for each type of user-interface component, which is known to the HI compiler. For example, the symbol for a menu bar is “* MenuBar”. When source code written in the HI programming language is compiled, upon encountering the symbol “* MenuBar”, the HI compiler may automatically generate code that, when executed, creates a menu bar in a user interface for display. Similarly, the symbol for a menu is “* Menu”, which signals to the HI compiler to generate code that, when executed, creates a menu in a user interface for display. The symbol for a menu item is “* MenuItem”, which signals to the HI compiler to generate code that, when executed, creates a menu item in a user interface for display. There may be other predefined symbols for other types of user-interface components. For example, the symbol “* window” signals to the Hi compiler to create and display a window; the symbol “* picture” signals to the Hi compiler to display an image; and so on.

In particular embodiments, the hierarchical relationship among a group of user-interface components may be defined by the placements of the individual user-interface components in the source code, and more specifically, base on the indentation of each line of code. For example, in the above CODE SAMPLE 6, the menu bar is at the first level of the hierarchy. Thus, the code “* MenuBar” at line 1 beings at the first character of line 1 (i.e., with no indentation). The two menus are at the second level of the hierarchy as they are included in the menu bar. Thus, the code “* Menu” at lines 2 and 6 begins at the fifth character of lines 2 and 6 (i.e., with one level of indentation). The three menu items are at the third level of the hierarchy as they are included in the two menus. Thus, the code “* MenuItem” at lines 4, 8, and 13 begins at the ninth character of lines 4, 8, and 13 (i.e., with two levels of indentation). In particular embodiments, each level of indentation signals to the Hi compiler that the corresponding user-interface component is one level further down the hierarchy.

In particular embodiments, a user-interface component may have data associated with it. For example, a menu item may have a title, a short-cut key, and a callback function (e.g., an event handler) that may be automatically invoked when a user performs an action upon the menu item. In the above CODE SAMPLE 6, for the menu item defined at lines 13 to 17, the title of the menu item is “Quit”, which is defined at line 14. The short-cut key of the menu item is “CMD+Q”, which is defined at line 15. The callback function of the menu item is “exit ( )”, which is defined at line 17. In particular embodiments, data associated with a user-interface component may be individually defined for the user-interface component with code nested with the user-interface component (e.g., using the appropriate level of indentation). For example, at line 14 the code “title=‘Quit’” begins at the thirteenth character on that line (i.e., with three levels of indentation) because this title is the title of the menu item and thus is further indented one more level from the level of the menu item itself. On the other hand, at line 7 the code “title=‘File’” begins at the ninth character of on that line (i.e., with two levels of indentation), signaling to the HI compiler that this is the title of the menu defined at line 6, not of any other user-interface component.

Although in some cases, the HI compiler may automatically generate callback functions in response to certain predefined symbols of the HI programming language, in other cases, programmers may wish to write callback functions manually. For example, a callback function may be defined for and associated with a user-interface component (i.e., as its event handler). Moreover, a programmer may wish to specify what specific event actually triggers a callback function being invoked. In particular embodiments, there are predefined symbols of the HI programming language that indicate to the HI programming language which callback function is associated with which object and what event causes a callback function to be invoked.

In the above CODE SAMPLE 6, at line 17, the menu item “Quit” is associated with a callback function “exit ( )”. At line 16, there is a predefined symbol “On command:”. In particular embodiments, this predefined symbol indicates to the HI compiler that, first, the function “exit ( )” is a callback function that should be associated with the menu item “Quit”, and second, the callback function “exist ( )” should be invoked automatically whenever a user inputs a command through the menu item “Quit”.

In particular embodiments, upon encountering the “On command:” symbol, the HI compiler may automatically generate appropriate code (e.g., in the C programming language) to support and handle the user-defined callback function. The following SAMPLE CODE 7 illustrates the code generated by the HI compiler in response to the code at lines 16-17 in SAMPLE CODE 6. Although the callback function “exist ( )” at line 17 in SAMPLE CODE 6 is relatively simple, with the code generated by the HI compiler illustrated in SAMPLE CODE 7, there is some setup overhead. The “struct” object below describes the function so it can be referenced when an object is constructed to represent the function in the HI programming language.

| | |
|---|---|
| 1 | static HiObject* Function_fb_23_call( |
| | HiObject* function, HiScope* outerScope, HiObject** |
| | closure, void** xclosure, HiObject** args) { |

| | |
|---|---|
| 2 | HiScope* scope = NULL; |
| 3 | HiObject *self = NULL, *e1 = NULL, *e2 = NULL; |
| 4 | HiArgument e0[ ] = {{0,NULL,0}}; |
| 5 | self = HiScopeObject(outerScope); |
| 6 | scope = HiScopeCreateCallScope(outerScope); |
| 7 | e1 = HiScopeGet(scope, HI_exit); |
| 8 | e2 = HiCall(e1, e0); |
| 9 | return HiNull( ); |

| | |
|---|---|
| 10 | } |
| 11 | static HiFunctionDef _Function_fb_23 = { |

| | |
|---|---|
| 12 | Function_fb_23_call, |
| 13 | NULL, |
| 14 | “fb:on command”, |
| 15 | NULL, |
| 16 | 0, |
| 17 | 0, |
| 18 | 0, |
| 19 | 0, |
| 20 | 0, |
| 21 | 0, |
| 22 | 0, |

| | |
|---|---|
| 23 | }; |
| 24 | HiFunctionDef* Function_fb_23 = &_Function_fb_23; |

### Code Sample 7

### Code Generated by the HI Compiler in the C Programming Language

A button is another type of user-interface component. Typically, a user may click a button. In particular embodiments, there is a predefined symbol “On click:” that may be associated with any clickable user-interface component (e.g., button, hyperlink, check box, etc.). This predefined symbol indicates to the HI compiler that the callback function associated with the clickable user-interface component should be invoked automatically whenever a user clicks on the user-interface component. The following source code written in the HI programming language illustrates an example of using the “On click:” symbol.

| | |
|---|---|
| 1 | * picture = Picture: location = #source, box = |
| | Flexible( ) |

| | |
|---|---|
| 2 | On click: |

| | |
|---|---|
| 3 | source = − |

### Code Sample 8

### Usage of the “On Click:” Symbol in the HI Programming Language

The following SAMPLE CODE 9 illustrates the code generated by the HI compiler in the C programming language in response to the code at lines 2-3 in SAMPLE CODE 8.

| | |
|---|---|
| 1 | static HiObject* Function_fb_167_call( |
| | HiObject* function, HiScope* outerScope, HiObject** |
| | closure, void** xclosure, HiObject** args) { |

| | |
|---|---|
| 2 | HiScope* scope = NULL; |
| 3 | HiObject *self = NULL, *e0 = NULL; |
| 4 | self = HiScopeObject(outerScope); |
| 5 | scope = HiScopeCreateCallScope(outerScope); |
| 6 | e0 = HiScopeSet(scope, HI_source, HiNull( )); |
| 7 | return HiNull( ); |

| | |
|---|---|
| 8 | } |
| 9 | static HiFunctionDef _Function_fb_167 = { |

| | |
|---|---|
| 10 | Function_fb_167_call, |
| 11 | NULL, |
| 12 | “PhotoViewer:on click”, |
| 13 | NULL, |
| 14 | 0, |
| 15 | 0, |
| 16 | 0, |
| 17 | 0, |
| 18 | 0, |
| 19 | 0, |
| 20 | 0, |

| | |
|---|---|
| 21 | }; |
| 22 | HiFunctionDef* Function_fb_167 = &_Function_fb_167; |

### Code Sample 9

### Code Generated by the HI Compiler in the C Programming Language

Sometimes, a user-interface component may change its value from time to time. For example, a progress bar may indicate the current status (i.e., progression) of a task being performed at a given time. As the task is being performed, the progress bar is updated accordingly to reflect the amount of work that has been completed. In particular embodiments, there is a predefined symbol “On change:” that may be associated with any object (e.g., user-interface component) whose value changes as time passes. This predefined symbol indicates to the Hi compiler that the callback function associated with the object should be invoked automatically whenever the value of the object changes.

There may be other predefined symbols in the form of “On XXX:”, with “XXX” indicating the specific condition under which a callback function may be automatically invoked, in the HI programming language. FIG. 3 illustrates an example method for a callback function to be associated with an object. In particular embodiments, suppose there is a block of source code written in the HI programming language that is compiled by the HI compiler, as illustrated in step 302. As the Hi compiler parses the block of source code, the HI compiler may counter an object (e.g., a user-interface component), a callback function, and a predefined symbol associated with the object (e.g., a symbol in the form of “On XXX:”), as illustrated in step 304. In response to the predefined symbol, the HI compiler may associate the callback function with the object so that the callback function is invoked automatically only if the condition indicated by the predefined symbol is satisfied in connection with the object (e.g., the object is clicked, the value of the change changes, or an command is inputted through the object), as illustrated in step 306.

Particular embodiments may be implemented on one or more computing devices. In particular embodiments, the HI compiler described above may be implemented as computer software having code embodied in computer-readable, non-transitory, and tangible storage medium. When the software is executed, it may cause one or more computing devices, or more specifically one or more processors of the one or more computing devices, to perform the functionalities supported by the HI compiler.

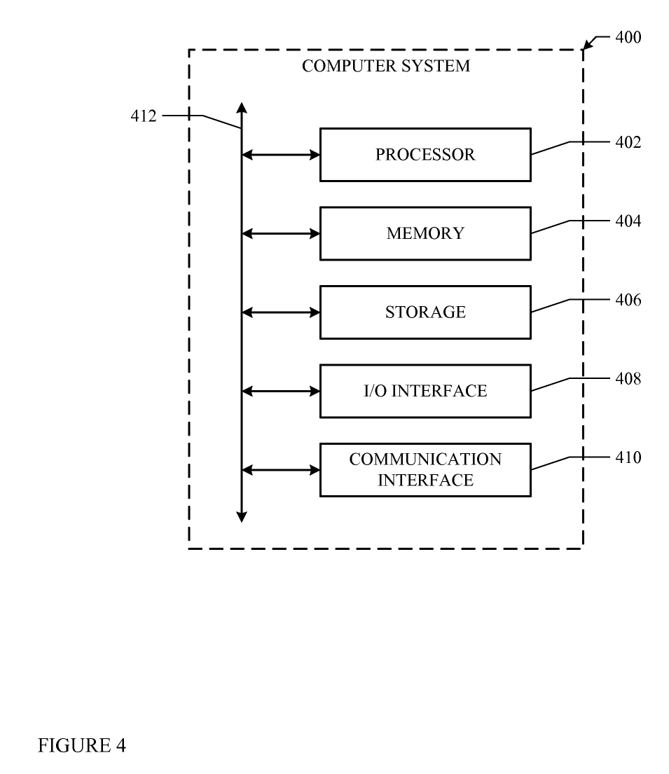

FIG. 4 illustrates an example computing device 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 400 may include one or more computer systems 400; be unitary or distributed; span multiple locations; span multiple machines; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. The present disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. The present disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include an HDD, a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 402 (such as, for example, one or more internal registers or caches), one or more portions of memory 404, one or more portions of storage 406, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A method comprising:
parsing, by a compiler, a function call that invokes a function and a first symbol associated with the function call; and
in response to the first symbol, generating, by the compiler, a first set of code that, when executed,
determines whether the function is associated with an activity; and
if the function is associated with an activity, then:
creates a first callback function for the activity; and
associates the first callback function with the activity so that the first callback function is automatically invoked when the activity is completed.

2. The method of claim 1, further comprising:
parsing, by the compiler, a second symbol associated with the function call, wherein the function is associated with the activity; and
in response to the second symbol, generating, by the compiler, a second set of code that, where executed,
displays a progress indicator associated with the activity;
creates a second callback function for the progress indicator; and
associated with second callback function with the progress indicator so that the second callback function is automatically invoked when an amount of the activity that has been completed changes.

3. The method of claim 1, further comprising:
parsing, by the compiler, a variable assignment that assigns a value to a variable and a second symbol associated with the variable assignment; and
in response to the second symbol, generating, by the compiler, a second set of code that, when executed,
creates a second callback function for the variable; and
associates the second callback function with the variable so that the second callback function is automatically invoked when the value of the variable changes.

4. The method of claim 1, further comprising:
parsing, by the compiler, a user-interface component, a second callback function, and a second symbol associated with the user-interface component; and
in response to the second symbol, generating, by the compiler, a second set of code that, when executed,
associates the second callback function with the user-interface component so that the second callback function is automatically invoked when a condition indicated by the second symbol is satisfied in connection with the user-interface component.

5. A compiler embodied as software stored in computer-readable non-transitory media, wherein the compiler is operable when executed by one or more computer systems to:
parse a function call that invokes a function and a first symbol associated with the function call; and
in response to the first symbol, generate a first set of code that, when executed, determines whether the function is associated with an activity; and
if the function is associated with an activity, then:
creates a first callback function for the activity; and
associates the first callback function with the activity so that the first callback function is automatically invoked when the activity is completed.

6. The compiler of claim 9, wherein the compiler is further operable when executed by the one or more computer systems to:
parse a second symbol associated with the function call, wherein the function is associated with the activity; and
in response to the second symbol, generate a second set of code that, where executed,
displays a progress indicator associated with the activity;
creates a second callback function for the progress indicator; and
associated with second callback function with the progress indicator so that the second callback function is automatically invoked when an amount of the activity that has been completed changes.

7. The compiler of claim 9, wherein the compiler is further operable when executed by the one or more computer systems to:
parse a variable assignment that assigns a value to a variable and a second symbol associated with the variable assignment; and
in response to the second symbol, generate a second set of code that, when executed,
creates a second callback function for the variable; and
associates the second callback function with the variable so that the second callback function is automatically invoked when the value of the variable changes.

8. The compiler of claim 9, wherein the compiler is further operable when executed by the one or more computer systems to:
parse a user-interface component, a second callback function, and a second symbol associated with the user-interface component; and
in response to the second symbol, generate a second set of code that, when executed,
associates the second callback function with the user-interface component so that the second callback function is automatically invoked when a condition indicated by the second symbol is satisfied in connection with the user-interface component.

9. A system comprising:
a memory comprising instructions executable by one or more processors; and
the one or more processors coupled to the memory and operable to execute the instructions, the one or more processors being operable when executing the instructions to:
parse a function call that invokes a function and a first symbol associated with the function call; and
in response to the first symbol, generate a first set of code that, when executed,
determines whether the function is associated with an activity; and
if the function is associated with an activity, then:
creates a first callback function for the activity; and
associates the first callback function with the activity so that the first callback function is automatically invoked when the activity is completed.

10. The system of claim 9, wherein the one or more processors are further operable when executing the instructions to:
parse a second symbol associated with the function call, wherein the function is associated with the activity; and
in response to the second symbol, generate a second set of code that, where executed,
displays a progress indicator associated with the activity;
creates a second callback function for the progress indicator; and
associated with second callback function with the progress indicator so that the second callback function is automatically invoked when an amount of the activity that has been completed changes.

11. The system of claim 9, wherein the one or more processors are further operable when executing the instructions to:
parse a variable assignment that assigns a value to a variable and a second symbol associated with the variable assignment; and
in response to the second symbol, generate a second set of code that, when executed,
creates a second callback function for the variable; and
associates the second callback function with the variable so that the second callback function is automatically invoked when the value of the variable changes.

12. The system of claim 9, wherein the one or more processors are further operable when executing the instructions to:
parse a user-interface component, a second callback function, and a second symbol associated with the user-interface component; and
in response to the second symbol, generate a second set of code that, when executed,
associates the second callback function with the user-interface component so that the second callback function is automatically invoked when a condition indicated by the second symbol is satisfied in connection with the user-interface component.

13. One or more computer-readable tangible storage media embodying software operable when executed by one or more computer systems to:
parse a function call that invokes a function and a first symbol associated with the function call; and
in response to the first symbol, generate a first set of code that, when executed,
determines whether the function is associated with an activity; and
if the function is associated with an activity, then:
creates a first callback function for the activity; and
associates the first callback function with the activity so that the first callback function is automatically invoked when the activity is completed.

14. The media of claim 13, wherein the software is further operable when executed by one or more computer systems to:
parse a second symbol associated with the function call, wherein the function is associated with the activity; and
in response to the second symbol, generate a second set of code that, where executed,
displays a progress indicator associated with the activity;
creates a second callback function for the progress indicator; and
associated with second callback function with the progress indicator so that the second callback function is automatically invoked when an amount of the activity that has been completed changes.

15. The media of claim 13, wherein the software is further operable when executed by one or more computer systems to:
parse a variable assignment that assigns a value to a variable and a second symbol associated with the variable assignment; and
in response to the second symbol, generate a second set of code that, when executed,
creates a second callback function for the variable; and
associates the second callback function with the variable so that the second callback function is automatically invoked when the value of the variable changes.

16. The media of claim 13, wherein the software is further operable when executed by one or more computer systems to:
parse a user-interface component, a second callback function, and a second symbol associated with the user-interface component; and
in response to the second symbol, generate a second set of code that, when executed,
associates the second callback function with the user-interface component so that the second callback function is automatically invoked when a condition indicated by the second symbol is satisfied in connection with the user-interface component.
